(19) United States
(12) Patent Application Publication
(10) Pub. No.: US 2011/0235177 A1
(43) Pub. Date: Sep. 29, 2011

(54) ATHERMAL ABIREFRINGENT OPTICAL COMPONENTS

(75) Inventor: George Dubé, Chesterfield, MO (US)

(73) Assignee: METASTABLE INSTRUMENTS, INC., St. Charles, MO (US)

(21) Appl. No.: 13/154,397

(22) Filed: Jun. 6, 2011

Related U.S. Application Data
(62) Division of application No. 11/271,224, filed on Nov. 12, 2005.
(60) Provisional application No. 60/628,045, filed on Nov. 15, 2004.

(51) Int. Cl. G02B 5/30

(52) U.S. Cl. 359/489.04

(57) ABSTRACT

An optical device to reduce the thermally induced distortion and thermally induced depolarization of light transmitted through all or part of the device. The device includes a nominally transparent element having a negative dn/dT and a nominally transparent element having a zero or negative stress optic coefficient.

### CROSS-REFERENCE TO RELATED APPLICATIONS

The present application is a divisional of U.S. patent application Ser. No. 11/271,224 filed Nov. 12, 2005, which claims priority to Provisional Patent Application No. 60/628,045, filed Nov. 15, 2004, the contents of said applications are incorporated herein by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contract No. N00024-04-C-4171 awarded by the Department of the Navy.

### FIELD OF THE INVENTION

This invention relates to windows and similar optical components. More specifically, the invention relates to an abirefringent athermal component that neither depolarizes nor distorts a light beam it is interacting with even if a temperature change or temperature gradient is created within the component

### BACKGROUND OF THE INVENTION

The performance of optical components, such as windows, lenses and reflectors, is generally affected by the temperature of the component. For example, when the temperature, refractive index, and the size of the window changes. Both of these temperature dependent effects alter the optical path (product of refractive index and distance the light travels) of light through the window.

If the temperature is not uniform throughout the component, the thermal expansion of the material causes stress within the material. These stresses additionally alter both the refractive index and the dimensions of the component. These changes are more complicated to model because they are not scalar properties that depend only on the temperature. For example, stressing a material in one direction not only changes the size of the material along that axis, but also along the orthogonal axes by an amount proportional to Poisson's Ratio for that material. The presence of a linear stress in an originally isotropic material generally alters the refractive index for light polarized perpendicular to the stress by a different amount than the index change for light polarized parallel to the stress. Two stress-optic coefficients, [symbol] and [symbol] are required to relate the change in refractive index to the amount of stress at that location for light polarized parallel to and perpendicular to the stress, respectively. The magnitude of each stress-optic constant affects the change in refractive index and distortion of the transmitted wavefront. The difference between the two stress-optic constants creates stress birefringence in the material. This birefringence depolarizes light transmitted through the material.

In the case of high average power light beams, the light beam itself heats and stresses the window or optical component, resulting in both distortion and depolarization of the transmitted light. The fraction of light absorbed is often less than 1%, but with laser powers greater than 10 kilowatts, the window must dissipate many 10's of Watts. The useful power output of certain high power lasers is currently limited by the laser induced thermal distortion and/or depolarization of the beam by the output coupler of the laser. It is the goal of this invention to create windows and/or related optical components that minimize the thermal distortion and depolarization of light beams interacting with them.

One prior art technique for minimizing laser induced distortion of a beam by a window is to use an athermal material in which the optical path change from a negative dn/dT counters the positive change in optical path from thermal expansion and stress. Calcium fluoride and certain optical glasses have this property. It has proven impractical and expensive to develop athermal materials that also meet the other requirements for high power optical applications. A second prior art technique is to place a liquid layer in parallel with the original (distorting) window. A second window is then necessary to contain the liquid layer. The windows thermally focus the light and the liquid layer thermally defocuses the light. With the proper choice of thicknesses, the total distortion through the compound window can be minimized. None of these prior art distortion reducing techniques minimizes depolarization.

One prior art way to keep the change in optical path through a window the same for light of any polarization (to eliminate birefringence) is to use two identical windows in parallel and place between them a device that rotates the plane of polarization by 90 degrees. If the light path is symmetrical through both windows, a ray of light that traverses the first window polarized parallel to the stress will traverse the second window polarized perpendicular to the stress. After traversing both elements, the depolarization is compensated. Unless both windows and the polarization rotator are athermal, the transmitted beam will be distorted but not depolarized. A second prior art technique is to use a window material that has a zero stress optic coefficient (SOC). A glass with this property is known as a Pockels Glass. These glasses have been commercially available for many decades and are recently available with very low absorption. Low absorption is required to reduce the heating and stressing of the windows. Certain crystals may also have a very small SOC. This prior art technique, like the first one, minimizes the depolarization of a beam, but does not minimize its distortion.

Thermal management has also been used to reduce distortion and depolarization. For example, face cooling of a window minimizes stress perpendicular to the direction of beam propagation, which minimizes distortion. The beam must then go through the coolant, which is often impractical.

### SUMMARY OF THE INVENTION

The present invention comprises an optical device to reduce the thermally induced distortion and thermally induced depolarization of light transmitted through all or part of the device. The device comprises a nominally transparent element having a negative dn/dT and a nominally transparent element having a zero or negative stress optic coefficient.

### BRIEF DESCRIPTION OF THE DRAWINGS

FIG. 1 is a diagrammatic view of a device according to the present invention comprising two windows and a liquid layer;

FIG. 2 is a diagrammatic view of a device according to the present invention comprising two windows with different stress optic coefficients of different signs;

FIG. 3 is a diagrammatic view of a device according to the present invention comprising two windows made from differently thermally focusing materials and a liquid layer;

FIG. 4 is a diagrammatic view of a device according to the present invention comprising two windows having different stress optical coefficients and at least one window made from a thermally defocusing material and a liquid layer;

FIG. 5 is a diagrammatic view of a device according to the present invention comprising two windows and a polarization rotator;

FIG. 6 is a diagrammatic view of a device according to the present invention comprising two windows, a liquid layer, and a reflector;

FIG. 7 is a diagrammatic view of a device according to the present invention comprising window movement mechanism to adjust the thickness of a liquid layer;

FIG. 8 is a diagrammatic view of a device according to the present invention comprising a pump to circulate a liquid;

FIG. 9 is a diagrammatic view of a device according to the present invention comprising a linear window movement mechanism; and

FIG. 10 is a diagrammatic view of a device according to the present invention comprising a curved surface on one or more elements of the device.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The goal is an optical component that maintains a constant optical path for light of any polarization no matter what temperature distribution and thermally induced stress distribution exist within the component. The optical path (OP) is the product of the refractive index (n) times the distance the light travels through material with that refractive index (d). If the OP does not change during light beam induced temperature excursions, the component will not distort the beam.

Each of the prior are techniques described above that reduce the depolarization of the transmitted light distorts the light because of the thermally induced change in optical path (OP) due to stress and/or temperature. Typically the optical path increases as the temperature increases. Typical glass windows when heated in the center by the transmission of a high power laser beam will thermally focus this beam because the central region of the window has an increased temperature and increased optical path.

One way to compensate for this distortion is to add a material that introduces a negative thermal change to the OP without also introducing birefringence. Transparent liquids are such a material. A liquid does not retain stress as a solid does and all common liquids have a negative dn/dT, due in large part to their positive thermal expansion coefficient which reduces their density and refractive index at higher temperatures. Prior art has shown that a thin liquid layer can correct several wavelengths of change in OP caused by laser irradiation that heats the layer. The thickness of the layer must be kept small enough and the viscosity of the liquid high enough that convection currents do not occur, as convection currents would irregularly distort the beam.

Some solid materials, such as barium fluoride have a dn/dT coefficient that is so negative that the optical path of the window decreases with an increase in temperature. The negative change in OP due to the negative dn/dT is large enough to overcome the positive change in OP due to the positive thermal expansion and stress. In some cases, such a material might replace the liquid described in the previous paragraph.

Optical materials chosen to transmit light beams, such as glasses, fused silica, silicon, and zinc selenide are manufactured and selected to be highly transmissive of that light. High quality transparent materials feature absorption and scattering coefficients less than 0.001 cm⁻¹ so that more than 99.8% of the light is internally transmitted through each centimeter thickness of the material. Typically only a very small fraction of the light is absorbed by the material and/or by any coatings on it, but with very high power beams even this small absorption heats the material and creates temperature gradients within the material. For example, a one centimeter thick window with an absorption coefficient (b) of 0.0001 cm⁻¹ will absorb 10 W from a 100 kW light beam. We have demonstrated distortions of approximately three wavelengths of light through a window absorbing one Watt.

For high average power laser beams, the distortions result from the heating of the optical component by the laser beam. In high peak power lasers, nonlinear and self-focusing effects may also contribute to distorting the beam. Both effects may be present if a high average power laser beam contains short (<1 microsecond) spikes of high peak power.

The temperature distribution in the transmitting optical element will be affected by the power density of the light beam, the absorption coefficient of the material, any extra absorption at the surface, the thermal properties of the material and the cooling conditions that remove the heat. In extreme cases distortion of the light will also alter the temperature distribution by concentrating the light in certain down stream locations, resulting in additional heating of those locations. Most of the important material properties, such as absorption coefficient, thermal expansion and thermal conductivity vary with temperature.

The changed temperature alters the optical properties of the optical component through several phenomena. Typically these phenomena are separated into (1) changes in dimensions from thermal expansion, (2) changes in refractive index from temperature, (3) changes in dimensions from stress and (4) changes in refractive index from stress.

Thermal expansion changes the size of the component as a function of temperature. This can be expressed as

D(T)=D(Tₒ)(1+ΔTα) Eq. 1

Where D(T) is the linear dimension of the component at temperature T, α is the coefficient of linear thermal expansion for that material, Tₒ is the ambient temperature and ΔT is the difference between T and Tₒ (T=Tₒ+ΔT). Most transparent solid materials have a positive coefficient of linear thermal expansion, but a few have a very small or even negative value.

The refractive index as a function of temperature n(T) can be expressed as,

n(T)=n(Tₒ)+Δnₜ=n(Tₒ)+ΔT(dn/dT) Eq. 2

where

Δnₜ=ΔT(dn/dT) Eq. 3

Δnₜ is the change in index resulting from ΔT and dn/dT is the coefficient of change in refractive index with temperature. Most solid transparent optical materials have a positive dn/dT, but there are several with a negative dn/dT.

In an “athermal” window material the negative change in OP from a negative dn/dT is equal but opposite of the positive change in optical path from the positive thermal expansion. Calcium fluoride and certain optical glasses are approximately athermal. A transmitting optical component at uniform temperature in air will be athermal when,

dn/dT=−α(n−1) Eq. 4

Usually α is positive and n is greater than one, so this athermal condition can only be met with a negative dn/dT. If dn/dT is more negative than −α(n−1) the OP through the material decreases as the temperature increases. If dn/dT is less negative than −α(n−1) the OP through the material increases as the temperature increases.

An optical component that is uniformly raised to a higher temperature will not distort a beam, although it may change the OP experienced by the beam. Thermally induced distortion of a transmitted optical wavefront by an optical component results from temperature gradients in the component. A temperature gradient causes distortion through three effects, thermal expansion, the temperature dependence of the refractive index (dn/dT) and stress.

The first two effects (thermal expansion and dn/dT) are scalar, depending only on the temperature, but the effect of stress on the refractive index and dimensions of the material is more complicated. The change in refractive index for light polarized parallel to the stress (Δ [symbol] ) is generally different than the change for light polarized perpendicular to the stress (Δ [symbol] ).

The change in refractive index resulting from a stress (S) can be expressed as

Δ [symbol] =−0.5nₒ³ [symbol] S Eq. 5

for light polarized parallel to the stress, and as

Δ [symbol] =−0.5nₒ³ [symbol] S Eq. 6

for light polarized perpendicular to the stress, where nₒ is the refractive index with no stress present and [symbol] and [symbol] are the stress-optic coefficients for light polarized parallel to and perpendicular to the stress, respectively. There are materials with both positive and negative values of [symbol] and [symbol] .

The stress induced birefringence can be expressed by

Δn_{sb}=Δ [symbol] −Δ [symbol] =0.5nₒ³( [symbol] − [symbol] )S=SOC(S) Eq. 7

where SOC is the stress optical coefficient,

SOC=0.5nₒ³( [symbol] − [symbol] ) Eq. 8

In some practical situations the distortion (and birefringence) from the stress are small compared to the distortion from thermal expansion and dn/dT. However, this is not always the case. Most materials have a positive stress-optic coefficient (SOC), but there are materials with a nearly zero SOC and materials with a negative SOC. In practical applications the thermal stress must be kept below the fracture limit of the component.

This difference in refractive index for light of orthogonal polarizations (birefringence) results in depolarization of polarized light that is not parallel or perpendicular to the stress. In the case of a round window, a laser beam heating the center of the window causes radial stress and any linearly polarized beam will become depolarized as its polarization is neither perpendicular to nor parallel to the stress at most positions in the aperture.

Stress also alters the shape of a component. A stress in the x direction not only alters the dimension of the component in the x direction, it also alters the dimension in the y and z directions. The magnitude of the orthogonal changes is proportional to the Poisson's Ratio for that material.

It is the object of this invention to construct windows and other optical elements that eliminate or greatly reduce distortion and depolarization. We refer to such a window as being athermal and abirefringent. The condition that such a window must meet is that the OPs through the window remain unchanged in the presence of temperature changes and temperature gradients.

The presence of stress alters the OP through the component. Nonetheless there is some value of a negative dn/dT that can make the total change in OP decrease with an increase in temperature. A large and negative dn/dT is crucial to making athermal abirefringent windows.

One case of concern is a high average power laser beam irradiating the central portion of an output coupler, window or other optical component of thickness d. Some fraction of the light is absorbed at each surface (which may be coated) and in the bulk of the material. This heating typically results in the central (on axis) portion of the component being at a higher temperature than its rim. Most window materials have a positive dn/dT and a positive α, so upon laser irradiation the center of the window develops a higher refractive index and becomes thicker. Both effects increase the optical path (nd) near the center of the window and cause the window to focus the light.

Barium fluoride is one example of a material with a negative dn/dT that is large enough to result in thermal defocusing of a beam. The decrease in optical path from the negative dn/dT is larger than the increase in OP from the positive thermal expansion and stress.

A number of prior art approaches have been used to make optical components that minimize the distortion they impart to an incident optical beam that is intense enough to heat the component. One is to develop athermal optical materials for those components. This is a straightforward approach, but it has proven difficult to cost-effectively develop materials that are athermal and also meet all of the other requirements, such as high homogeneity of refractive index in large sizes, low defect density, high strength, high durability, low loss and good polishing properties. Prior art athermal materials have not minimized birefringence. In addition a material that is athermal for uniformly heated components is not athermal for locally heated components (because of the Poisson's Ratio and stress-optic effects described above). Similarly, a material that is athermal for a window is not athermal for a lens (because the heating also changes the curvature of the lens surface). Thus a different athermal material must be produced for each application. The subject invention does not require the development of any new materials.

A second prior art approach is to measure the distortion and correct it with actively controlled adaptive optical components. This approach is expensive, but has made considerable progress in reducing distortion of beams distorted by transmission through the atmosphere. Atmospheric distortion changes rapidly and randomly, so there may be no hope of a passive technique for that application. The present invention's less expensive approach should suffice for the slower, more repeatable and more predictable distortions caused by laser induced thermal gradients in optical materials. Current adaptive optical systems do not correct for nor reduce birefringence.

A third prior art approach is to combine two optical materials such that the thermally induced change in OP (distortion) from one material compensates for the distortion from the other, resulting in zero total distortion for light incident on this compound window. In the presence of step gradients in the refractive index, a light ray will deviate from its original direction. For this reason it may be important to use thin, closely spaced windows to minimize the walk-off of the beam. None of the prior art executions of this concept also reduced thermally induced birefringence which depolarizes a transmitted beam.

The goal is to keep the optical path (OP) through a compound window unchanged as a function of temperature and stress for all polarizations. Exact calculations of the change in OP are often difficult. With or without calculations, experimental measurements may be used to determine the actual OP performance during laser irradiation. We have used an interferometer and a polariscope to measure the distortion and birefringence, respectively of various optical components during laser irradiation. By switching polarizations in the interferometer one can eliminate the need for a polariscope. The same light beam that heats the component(s) may also be used to measure the distortion and/or depolarization of the transmitted beam.

The concept for minimizing changes in the OP is that whatever positive change in the optical path is created by one element, there is a certain thickness of another element that can compensate for that optical path change by creating a negative change of the same magnitude. If depolarization is to be avoided also, some method must be found to keep the change in OP the same for light of any polarization (to eliminate thermally induced birefringence).

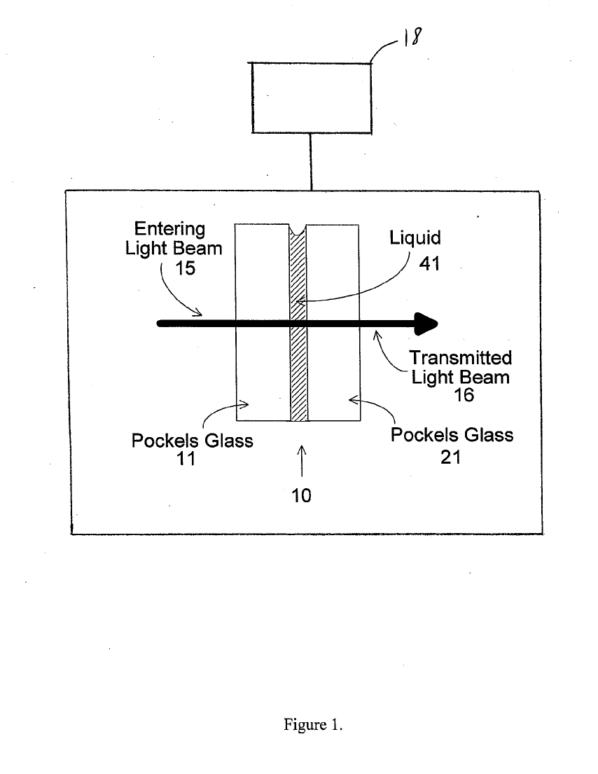

In the first embodiment of the present invention (collectively 10 in FIG. 1) the birefringence problem is solved by using two windows of Pockels Glass (11 and 12) to contain a liquid layer (41). Pockels Glass is commercially available in two different versions: Schott SF57HHT available from Schott Corporation of Germany and Duryea, Pa. and Ohara PBH56 available from Ohara Corporation, Branchburg, N.J. The attractive feature of these Pockels Glasses is that they have a nearly zero SOC. There are also a few crystals with similar properties. The liquid layer can be, for example, is Krytox GPL 106 oil available from DuPont Performance Lubricants, Wilmington, Del.

Neither the Pockels glass nor the liquid layer becomes birefringent upon laser irradiation. The glass has a zero stress optic coefficient (SOC), so it distorts the beam but does not depolarize it. Its distortion of the transmitted light beam (16) comes from dn/dT, the stress-optic constants (which are equal to each other) and thermal expansion due to both temperature and stress. The liquid does not support stress as a solid does so no stress effects contribute and it does not depolarize the beam, but it does distort the beam due to dn/dT. Thermal expansion of the liquid does not contribute as the thickness of the liquid is fixed by the windows. The thickness of the liquid is adjusted until it produces a decrease in OP equal to the increase in OP caused by the laser irradiation of the two glass windows. The maximum practical thickness of the liquid is limited by the onset of convection currents caused by laser irradiation. If a thickness greater than this is required, two or more thinner layers may be used. Liquids, gels or greases with higher viscosity and/or surface tension may allow thicker layers to be used. Optionally the device may include a temperature control unit (18) that controls or monitors the temperature of the Pockels glass (11 and 21) and the liquid (41) to minimize temperature dependent effects or indicate the temperature to determine a maximum acceptable power level of the light beam (15). Element 18 may also comprise a device for measuring the bowing of the Pockels glass (11 or 21) to determine the maximum acceptable power level of the light beam (15)

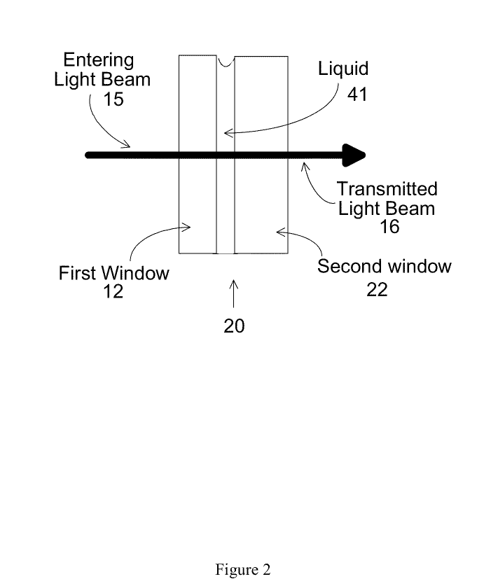

In a second embodiment of the present invention (collectively 20 in FIG. 2), two different window materials (12 and 22) and a liquid (41) are used. One window has a positive stress optic coefficient (SOC) and the other window has a negative SOC. The thickness of one window is adjusted so that the birefringence of the pair of windows is minimized upon laser irradiation. The thickness will be determined by the absorption of that window for the laser light, the thermal properties of that window and by the window's relative SOC values. Once the two window thicknesses are determined, the thickness of the liquid layer is adjusted to minimize the total distortion of the compound window.

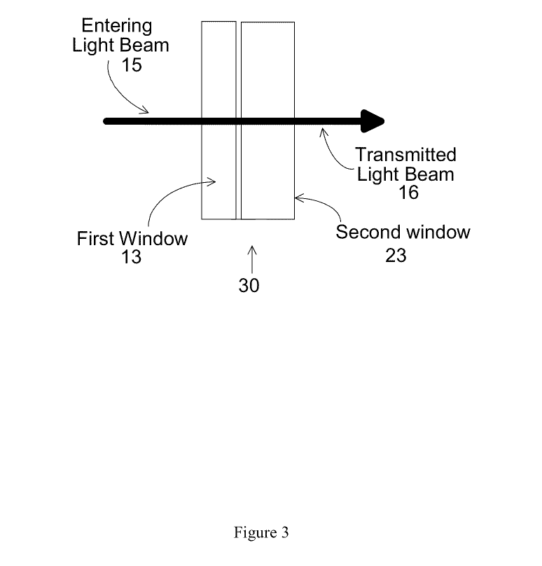

A third embodiment of the present invention (collectively 30 in FIG. 3) uses only two windows (13 and 23); one of a thermally focusing material and one of a thermally defocusing material. Ideally one window has a positive SOC, the other a negative SOC. If this compound window has unacceptable stress birefringence, a polarization rotator can be placed between two such windows. The windows may be air spaced, vacuum spaced or contacted together by a very thin layer of liquid. The thickness of the contacting liquid is so small that it does not play a role in compensating distortion, but it can reduce reflections at the interfaces, conduct heat between the two windows and allow the two solid materials to expand and contract without stressing the adjoining window.

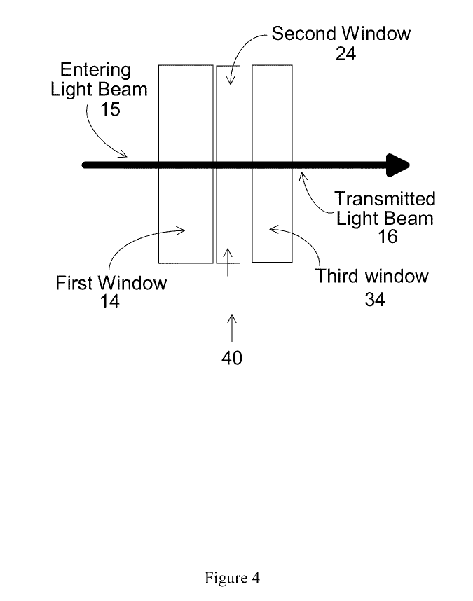

In a fourth embodiment of the present invention (collectively 40 in FIG. 4) at least one window must be thermally defocusing, at least one window must have a negative SOC and at least one window must have a positive SOC. The materials and thicknesses are chosen to meet two criteria. The first is the minimization of thermal distortion. The second is the minimization of stress birefringence. Only certain special combinations of materials will meet the required criteria using practical thicknesses. It is theoretically possible to meet these dual criteria with only two window materials, but the probability of meeting both criteria increases if three materials are used.

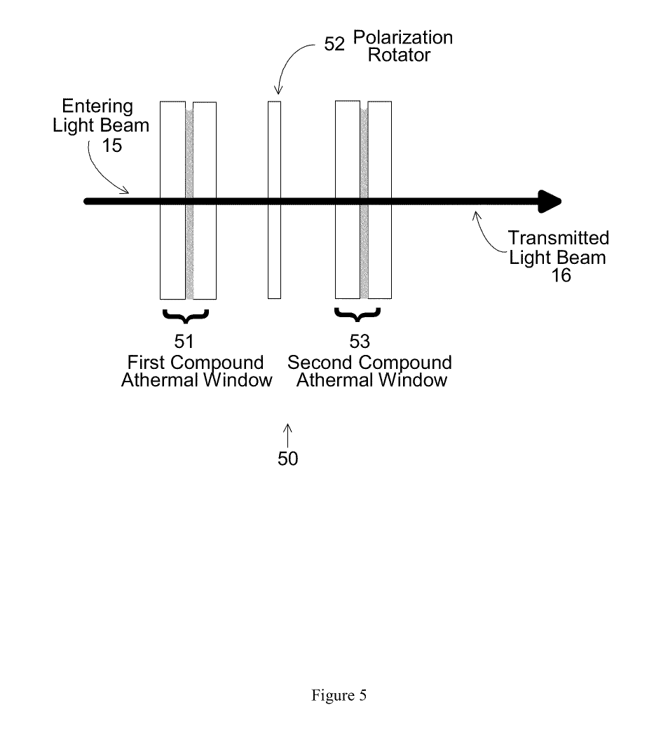

In a fifth embodiment of the present invention (collectively 50 in FIG. 5), two athermal compound windows (51 and 53) are positioned with a 90 degree polarization rotator (52) between them. These windows need not be abirefringent. If the stresses in the two windows are similar and the light follows a similar path through both windows, the polarization rotator minimizes the net birefringence of the combination and thus minimizes any depolarization of a transmitted beam. A ray traveling through the first window polarized parallel to the local stress will, because of the polarization rotator, travel through the second window polarized perpendicular to the stress. Every ray experiences equal amounts of parallel and perpendicular stress optic coefficients, so the light will not be depolarized. A negative dn/dT liquid provided in each window minimizes the distortion through each of the windows. In combination, the assembly functions as an athermal and abirefringent window that neither distorts nor depolarizes the transmitted light beam (16). If the polarization rotator (52) introduces any distortion or thermally induced changes in polarization, the second athermal window (53) may be adjusted to minimize the final distortion and depolarization of the transmitted beam (16).

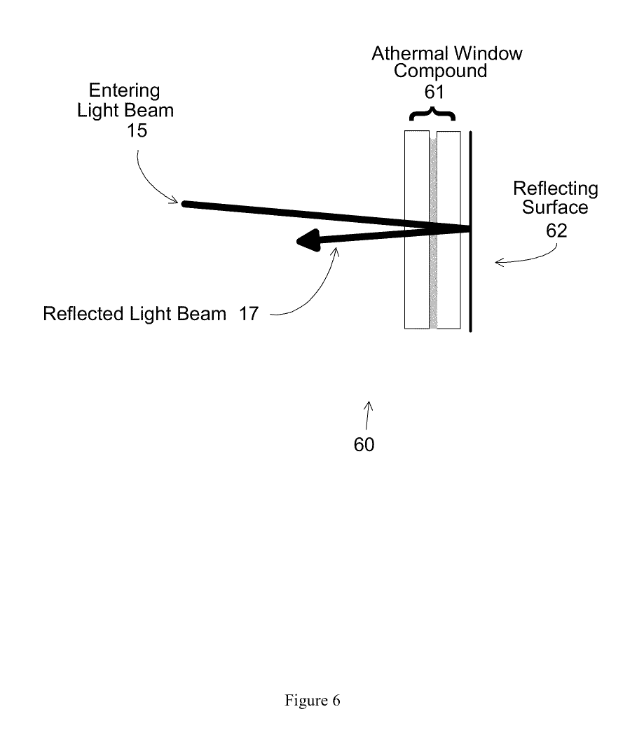

In a sixth embodiment (collectively shown as 60 in FIG. 6) a reflector (62) is added to an athermal abirefringent compound window (61) to make a device that minimizes the distortion and the depolarization of a reflected light beam (17). The reflector may be a part of the compound window or may be separate (as shown in FIG. 6). In general, the optimum thickness of the liquid will be different than the optimum thickness for a window that is transmitting a beam because of the distortion from the thermal deformation of the reflecting surface.

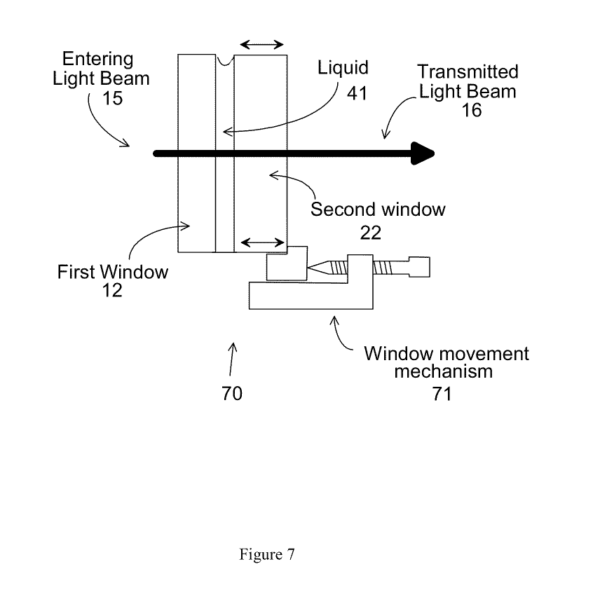

In a seventh embodiment (collectively shown as 70 in FIG. 7) a linear window movement mechanism (71) is provided to adjust the thickness of the liquid (41) in the athermal abirefringent compound window by moving at least one window (22) parallel to the direction of the light beam. This adjustment may be used to minimize the distortion of the compound window or to increase the thickness to allow the creation of convection currents which purposely distort the transmitted beam. Such purposeful distortion might be used to protect down stream components from damage by a laser beam that is too powerful or is focusing too strongly.

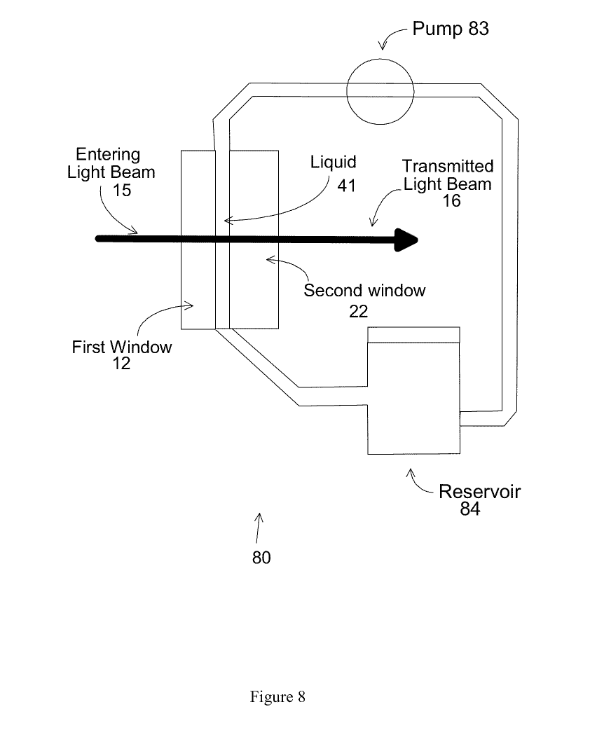

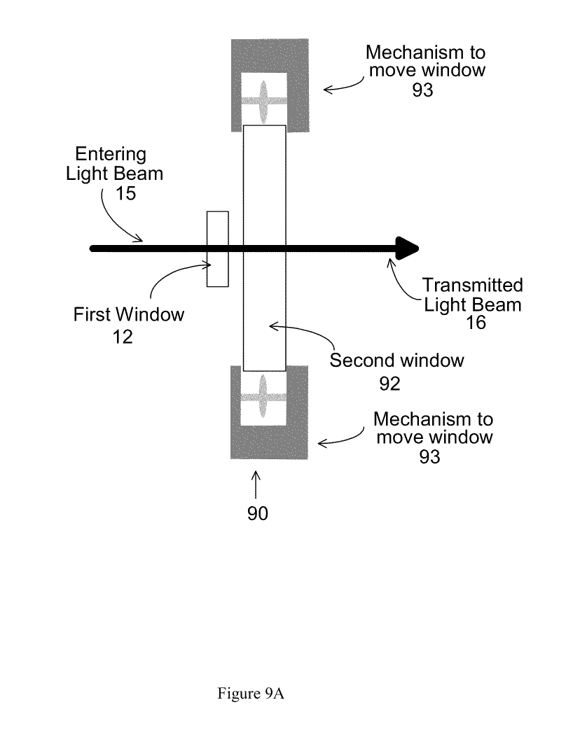

In an eighth embodiment (collectively shown as 80 in FIG. 8) a pump (83) is provided to circulate the liquid (41) through the athermal abirefringent compound window. This circulation may be used to keep the liquid and/or the windows from becoming too hot. A reservoir (84) may be included. Coolers for the liquid and inspection stations for the liquid may also be added. To minimize distortion created by the flowing of the liquid, two windows may be aligned with their flows in opposite directions.

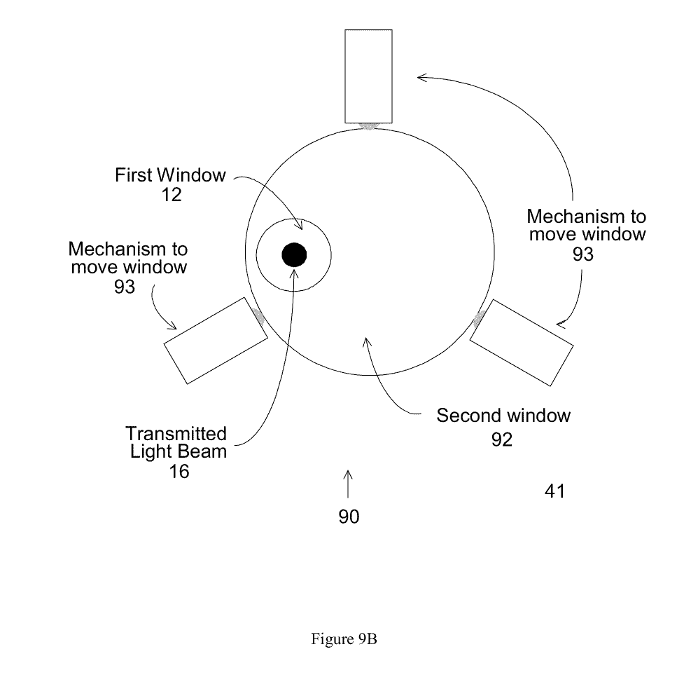

In a ninth embodiment (collectively shown as 90 in FIGS. 9A-side view and 9B-end view), a linear window movement mechanism (93) to move a window (92) perpendicularly to the direction of the light beam (15) is provided in an athermal abirefringent compound window. This movement may be used to keep the window from becoming too hot. To minimize distortion resulting from this movement, two windows may be moved in opposite directions. This is done by counter rotating both windows in a two window compound window or by rotating one window in each of two compound windows. In FIG. 9, the movement is a rotation, but linear translation may also be used.

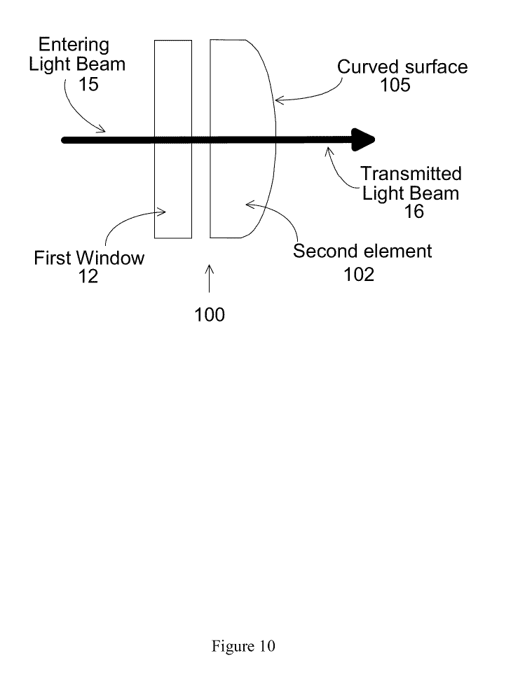

In a tenth embodiment (collectively shown as 100 in FIG. 10) a curved surface 105 is placed on one or more elements (102 in FIG. 10) in the compound optical device. A curved surface may be used to focus or defocus light either in transmission and/or reflection. In the case shown, the curved surface focuses the transmitted and reflected light.

While the specific embodiments have been illustrated and described, numerous modifications come to mind without significantly departing from the spirit of the invention, and the scope of protection is only limited by the scope of the accompanying claims.

I claim:

1. An optical device to reduce the thermally induced distortion and thermally induced depolarization of light transmitted through all or part of the device, the device comprising a nominally transparent layer of liquid, grease or gel in a thickness that minimizes the distortion of the device and a nominally transparent solid element having an approximately zero or negative stress optic coefficient.

2. The device of claim 1 wherein the refractive index of the nominally transparent liquid, grease or gel approximately matches the refractive index of the nominally transparent solid element.

3. The device of claim 1 further comprising a thin film coating that alters the magnitude of the reflection of light at an interface.

4. The device of claim 1 further comprising a reflective element positioned to reflect a light beam that has passed through at least one of the nominally transparent elements back through it.

5. The device of claim 4 wherein at least one of the nominally transparent elements is a quarter-wave plate oriented to convert incident plane polarized light into circularly polarized light in a single pass.

6. The device of claim 1 wherein at least one of the nominally transparent elements comprises a material selected from the group consisting of: glass, a single crystalline material, a polycrystalline or ceramic material, a polymeric material, and a frozen liquid or gel.

7. The device of claim 1 further comprising a temperature control unit.

8. The device of claim 1 wherein the nominally transparent liquid, grease or gel comprises a melted solid.

9. The device of claim 1 wherein an observation of the creation of one or more bubbles or convection currents in the nominally transparent liquid, grease or gel is used to indicate the maximum acceptable power level of a light beam incident upon the nominally transparent liquid, gel or grease.

10. The device of claim 1 further comprising a temperature indication unit to monitor the maximum acceptable power level of a light beam incident upon the device.

11. The device of claim 1 further comprising a solid element bowing detection unit to indicate the maximum acceptable power level of a light beam incident upon the device.

12. The device of claim 1 wherein interferometry and localized heating are used to optimize the thickness of the material(s).

13. The device of claim 1 wherein beam divergence measurements are used to optimize the thickness of the material(s).

14. The device of claim 1 further comprising a linear window movement mechanism to alter the thickness of the nominally transparent liquid, grease or gel.

15. The device of claim 1 further comprising a pump that circulates the nominally transparent liquid, grease or gel.

16. The device of claim 1 further comprising a linear window movement mechanism that moves at least one of the nominally transparent elements transverse to the direction of an incident light beam to reduce the temperature of that at least one nominally transparent element.

17. The device of claim 1 wherein an incident light beam is provided at non-normal incidence to reduce the reflection of light from an interface of at least one of the nominally transparent elements for p-polarized light.

18. The device of claim 1 wherein at least one of the nominally transparent elements comprises at least one nonplanar solid surface.

19. The device of claim 1 wherein the nominally transparent liquid, grease or gel is provided in a thickness that is sufficient to optically contact two solids but is too thin to affect thermally induced distortion as a result of its dn/dT.

20. The device of claim 1 wherein the absorption coefficient of the nominally transparent liquid, grease or gel is increased by the addition of another material.

21. The device of claim 3 wherein the thin film coating is added to purposely increase the absorption of the light.

22. The device of claim 4 further comprising a laser and wherein the nominally transparent elements are adapted to perform as an output coupler.

23. The device of claim 22 further comprising at least one radially varying reflectivity coating.
